(19) United States
(12) Patent Application Publication
(10) Pub. No.: US 2009/0200097 A1
(43) Pub. Date: Aug. 13, 2009

(54) ELECTRONIC STEERING SYSTEM FOR A VEHICLE

(75) Inventors: Bruce W. Farber, Oxnard, CA (US); Liming Yue, Camarillo, CA (US)

Correspondence Address: KELLY LOWRY & KELLEY, LLP, 6320 CANOGA AVENUE, SUITE 1650, WOODLAND HILLS, CA, 91367, US

(73) Assignee: Wiggins Lift Co., Inc., Oxnard, CA (US)

(21) Appl. No.: 12/030,010

(22) Filed: Feb. 12, 2008

(51) Int. Cl. B62D 5/04; G06F 19/00

(52) U.S. Cl. 180/443; 701/42

(57) ABSTRACT

An electronic steering system for a vehicle includes a generally freely rotating steering column, a sensor for determining a rotational position of the steering column and a controller for turning tires on the vehicle based upon the rotational position of the steering column. When the vehicle is switched to one of various steer modes the controller electronically resets the rotational position of the steering column to a zero rotational position without physically turning the steering column. A steering brake limits over-rotation of the steering column to prevent the tires on the vehicle from turning beyond a safe distance. The controller electronically resets the rotational position of the steering brake when the steer mode is changed.

### FIELD OF THE INVENTION

This invention relates to an electronic steering system for a vehicle. More particularly, the present invention relates to an electronic steering system for a boat lifting and stacking vehicle wherein the vehicle is capable of multiple steer modes and the tires are rotatable through one hundred eighty degrees.

### BACKGROUND OF THE INVENTION

Boat storage facilities continue to experience an increased demand in storage space due to an increase in boat ownership. Additionally, the shortage and high price of waterfront land increases the need for offshore boat storage facilities. Such boat storage facilities require specialized vehicles for lifting and stacking the boats in racks stretching horizontally and vertically throughout the facility.

One such specialized vehicle is the boat lifting and stacking vehicle described in U.S. Pat. No. 5,326,217 and U.S. patent application Ser. No. 11/877,174 filed Oct. 23, 2007, the contents of which are incorporated herein. Such specialized vehicles comprise an elongated frame having parallel side rails with a carriage mounted on the rails and movable along the length thereof. An upright mast and operator console are included on the carriage for lifting and carrying boats. Four or more independently steerable and drivable wheels are mounted on the frame near the corners thereof. Each of the wheels is rotatable through one hundred eighty degrees. The drive system of the vehicle permits multiple modes of steering, i.e., standard steering, radius steering, circle steering, crab steering and side steering.

Due to the rotatable nature of the wheels on such vehicles and the possibility of shifting steer modes, there is a need that the steering column be generally freely rotatable to allow for a one hundred eighty degree rotation of the tires and also to permit the vehicle to shift steer modes without physically returning the steering column to a zero rotational position. Prior art steering columns incorporate a mechanical stop to prevent rotation of tires on forklift trucks beyond ninety degrees at most. Such a mechanical stop requires manually turning the steering column until returned to a zero rotational position.

Accordingly, there is a need for an improved electronic steering column in a vehicle that does not include a mechanical stop. Such an electronic steering column should be capable of being reset to a zero rotational position by other than manual means when switching steer modes. The present invention fulfills these needs and provides other related advantages.

### SUMMARY OF THE INVENTION

An electronic steering system for a vehicle comprises a rotating steering column, a sensor for determining a rotational position of the steering column, and a controller for turning tires on the vehicle based upon the rotational position of the steering column. The controller turns the tires based upon the constraints of one of various steer modes for the vehicle. The controller also reestablishes a zero rotational position of the steering column when the vehicle is switched to another of the various steer modes. The reestablishment of a zero rotational position is achieved electronically rather than manually.

The electronic steering system further comprises a force feedback mechanism for limiting rotation of the steering column in either a clockwise or counter-clockwise direction. The force feedback mechanism preferably comprises an electronic brake or similar structure on the steering column. The force feedback mechanism prevents rotation of the steering column beyond one and one-half revolutions in either a clockwise or counter-clockwise direction. Preferably, the steering column has a rotation range between negative five hundred forty degrees and positive five hundred forty degrees. Switching to another of the various steer modes also reestablishes a zero rotational position of force feedback mechanism.

The electronic steering system also includes an electronic encoder associated with the steering column. The electronic encoder communicates the rotational position of the steering column to the sensor.

A method for controlling the electronic steering system in a vehicle comprises the steps of providing a rotating steering column; selecting a first steer mode for the vehicle which defines a first position and alignment of tires on the vehicle; establishing a zero rotational position of the steering column; selecting a second steer mode for the vehicle which defines a second position and alignment of tires on the vehicle; and electronically resetting the rotational position of the steering column such that the steering column is restored to the zero rotational position when switched to the second steer mode.

While in the first steer mode, the vehicle is operated such that the steering column undergoes a change in rotational position that alters the position and alignment of the tires according to constraints of the first steer mode. In addition, the vehicle is operated while in the second steer mode such that a change in the rotational position of the steering column alters the position and alignment of the tires according to constraints of the second steer mode.

The method further involves limiting rotation of the steering column, typically beyond one and one-half rotations in either a clockwise or counter-clockwise direction. Alternatively free rotation of the steering column may be limited to a range of between negative five hundred forty degrees and positive five hundred forty degrees. Further, the electronically resetting step may further comprise electronically resetting limits on rotation of the steering column.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 illustrates the type of boat lifting and stacking vehicle that may advantageously utilize the electronic steering system of the present invention;

FIG. 2 is a partial cross-section of a steering column embodying the present invention;

FIG. 3 is an illustration of a control panel for the steering system of the present invention;

FIG. 4 is a bottom view of a boat lifting and stacking vehicle carrying a boat in the crab steer position;

FIG. 5 is a bottom view of a boat lifting and stacking vehicle carrying a boat in the side steer position;

FIG. 6 is a bottom view of a boat lifting and stacking vehicle carrying a boat in the circle steer position;

FIG. 7 is a bottom view of a boat lifting and stacking vehicle carrying a boat in a radius steer position;

FIG. 8 is a bottom view of a boat lifting and stacking vehicle carrying a boat in the standard steer position;

FIG. 9 is a block diagram illustrating the input, controller and output systems of the electronic steering system of the present invention; and

FIG. 10 is a block diagram illustrating the operational control of the vehicle tires by the steering system.

### DETAILED DESCRIPTION OF THE PREFERRED EMBODIMENTS

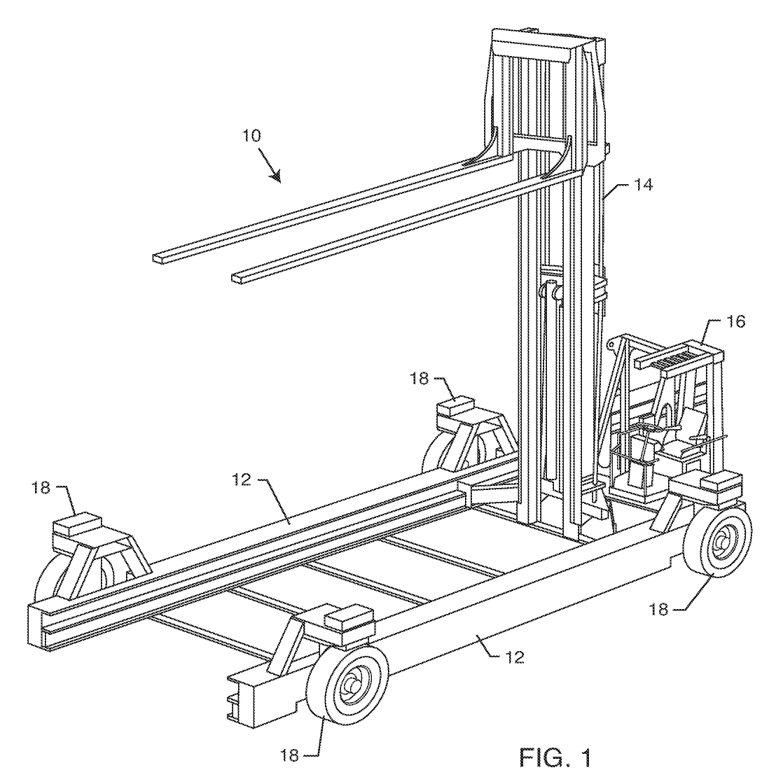

As shown in the exemplary drawings for purposes of illustration, the present invention is directed to an electronic steering system and a method for controlling the same in a boat lifting and stacking vehicle. FIG. 1 generally illustrates a boat lifting and stacking vehicle 10 which comprises a generally elongated frame having two parallel rails 12. A forklift mast 14 and a control console 16 are mounted on the vehicle 10. Proximate each of the four corners of the vehicle 10 is a wheel assembly 18.

The wheel assemblies 18 are configured to permit one hundred eighty degree rotation of the wheels, i.e., ninety degrees of rotation in both a clockwise and counter-clockwise direction from an initial position. Each of the wheels in the wheel assemblies 18 is independently steerable and drivable. This level of independent control over the wheels permits a wide range of steering movements.

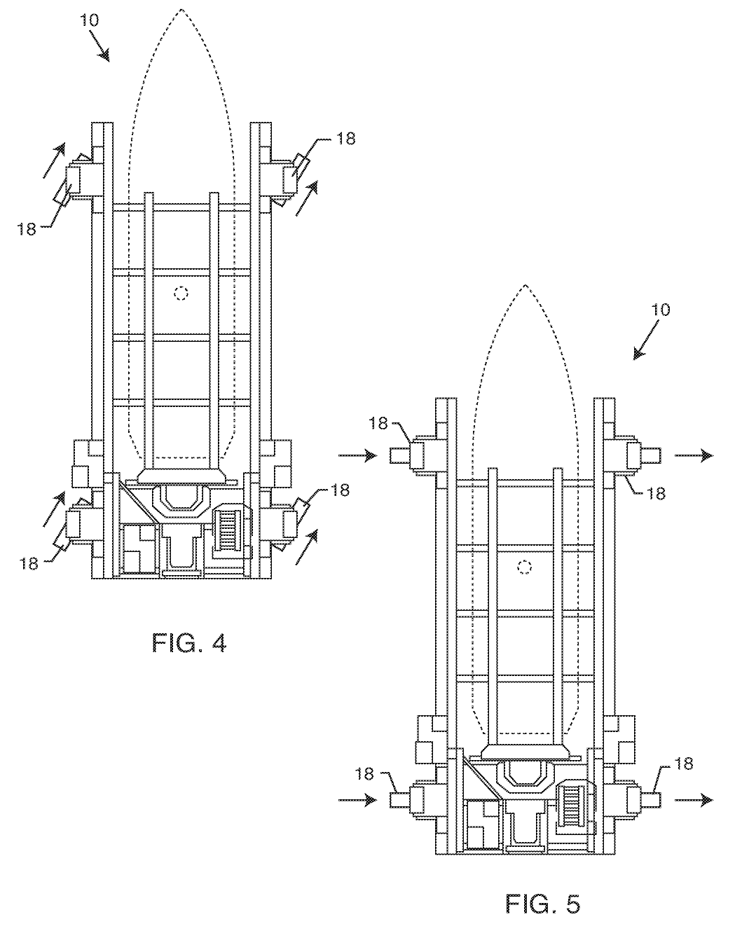

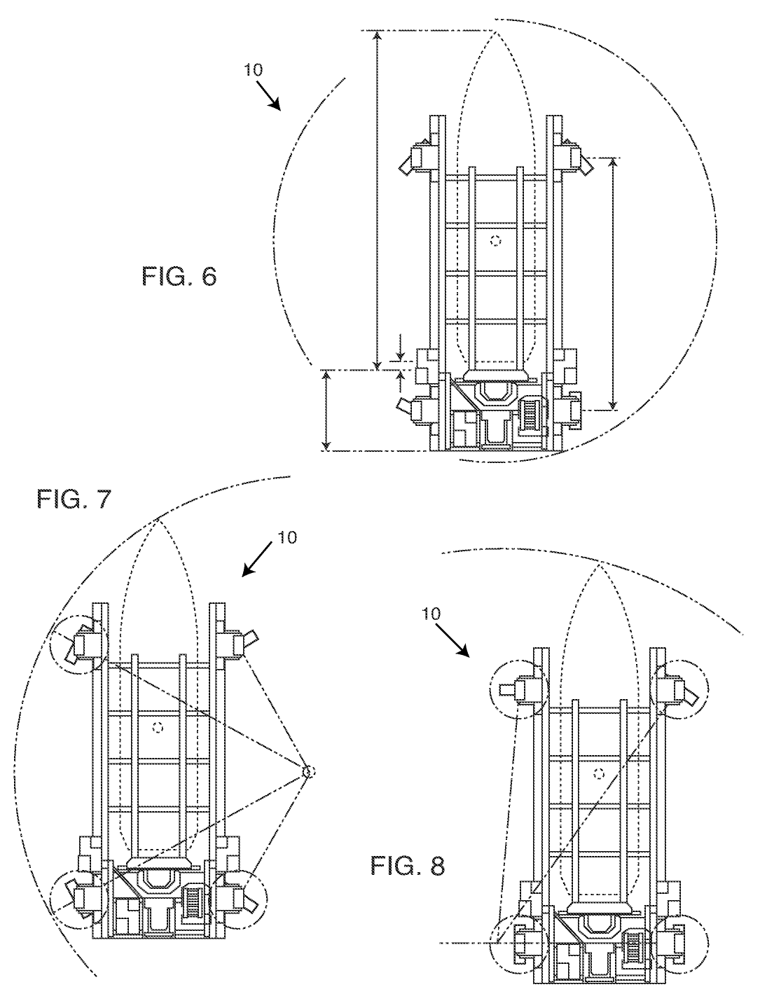

The steering movements permit a variety of steer modes as depicted in FIGS. 4-8. Such steer modes include a crab steer mode (FIG. 4), a side steer mode (FIG. 5), a circle steer mode (FIG. 6), a radius steer mode (FIG. 7), or standard steer mode (FIG. 8). In the various steer modes the wheels on the vehicle are placed in different starting positions as indicated. As the vehicle 10 is switched from one steer mode to another, the tires are automatically set in the position for the new steer mode.

With such switching of the steer modes, a standard mechanical steering system and steering column which includes a permanent mechanical stop, would need to be manually returned to a zero rotational position. Zero rotational position is meant to identify the midpoint of a full range of rotation of a steering column. The zero rotational position is the point at which the steering column can rotate an equal distance in either direction. To overcome the need to manually return a mechanical steering system to a zero rotational position, the electronic steering system eliminates the permanent mechanical stop.

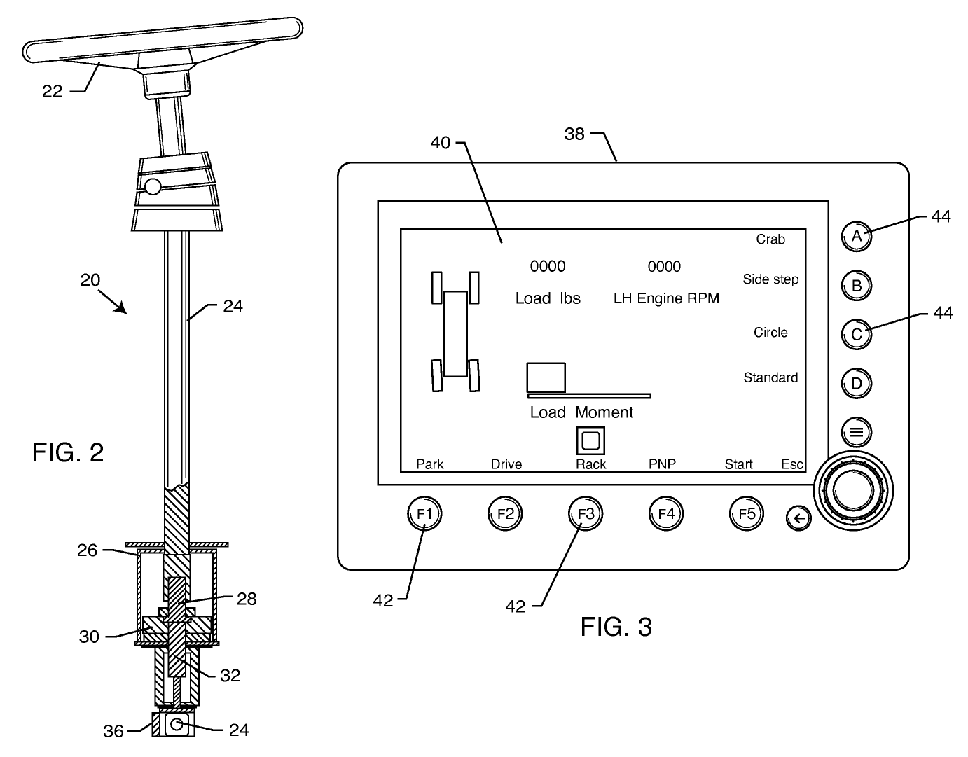

The electronic steering system of FIG. 2 comprises a rotating steering column 20 having a wheel 22, a shaft 24, a mounting bracket 26, an upper coupling 28, a steering brake 30, a lower coupling 32 and an encoder 34. The rotating steering column 20 is mounted in the operator console 16 and held in place by the mounting bracket 26. The shaft 24, upper coupling 28 and lower coupling 32 form a single rigid column that connects the steering wheel 22 to the encoder 34. As an operator turns the steering wheel 22, so turns the encoder 34. A sensor 36 mounted proximate the encoder 34 senses the degree of rotation of the encoder 34 to determine a rotational position of the steering column 20. The sensor 36 communicates this rotational position to a controller 38 which then manipulates the wheel assemblies 18 on the vehicle 10 according to steering constraints of the current steer mode.

The controller 38 in a housing is illustrated in FIG. 3. The controller 38 includes a display 40, a series of transmission buttons 42 and a series of steer mode buttons 44. The display 40 provides information about the load being carried by the vehicle 10, the current steer mode and wheel position, as well as the current state of the transmission, i.e., park, drive, rack, etc.

Although a permanent mechanical stop has been removed, the column 20 should not be without restraints on rotation. Stated another way, the steering column 20 should not be allowed to be rotated infinitely in any direction. To permit the steering column 20 to rotate endlessly in any one direction would cause over-rotation of the tires on the vehicle 10. Over-rotation means turning the steering column 20 such that the tires turn more than ninety degrees in either a clockwise or counter-clockwise direction. Such over-rotation would present mechanical problems for the wheel support assemblies 18 and prevent the proper control of and communication with the tires.

Preferably, the steering column 20 and the wheels have a rotation ratio such that five hundred forty degrees or one and one-half rotations in one direction will result in a ninety degree rotation of the wheels. Different rotational ratios may be set, however applicants have found the above ratio to work best.

In a preferred embodiment, the steering brake 30 acts as a limiting mechanism to restrict over-rotation of the steering column 20. As the steering column 20 approaches five hundred forty degrees or one and one-half rotations in one direction, the steering brake 30 begins to restrict rotation until it is stopped entirely at five hundred forty degrees of rotation.

In another preferred embodiment, the controller 38 is programmed to not recognize more than one and one-half or five hundred and forty degrees of rotation in either a clockwise or counter-clockwise direction. Such programming eliminates the need for the steering brake 30 while still preventing over-rotation of the steering column 20.

With a vehicle that is capable of multiple steer modes, it is important to be mindful of the rotational position of the steering column 20 when changing steer modes. If the steering column 20 is in any position other than a zero rotational position when the steer mode is switched, it would become necessary to note the current rotational position of the steering column 20 and adjust the initial position of the wheels accordingly. Such calculation and adjustment is difficult to program and creates the possibility for error. A prior art steering column requires the operator to manually return the steering column to the zero rotational position before switching steer modes. In contrast, the rotational position of the steering column 20 of the present invention is electronically reset to zero automatically when the steer mode is changed. The controller 38 automatically accepts the current signal from the sensor 36 as the zero rotational position of the column 20. For this reason there can be no permanent mechanical stops in the rotation of the steering column 20. In this sense the steering column 20 is freely rotating.

As with the rotational position of the steering column 20, when the steer mode is changed, the rotational position of the steering brake 30, when included, must be reset to zero as well. Every time an operator changes the steer mode of the vehicle, the rotational position of both the steering column 20 and steering brake 30 are reset to zero without the steering column 20 being physically turned. The resetting to zero position is done automatically by the controller 38 by accepting the current rotational position signal sent by the sensor 36 as the zero rotational position.

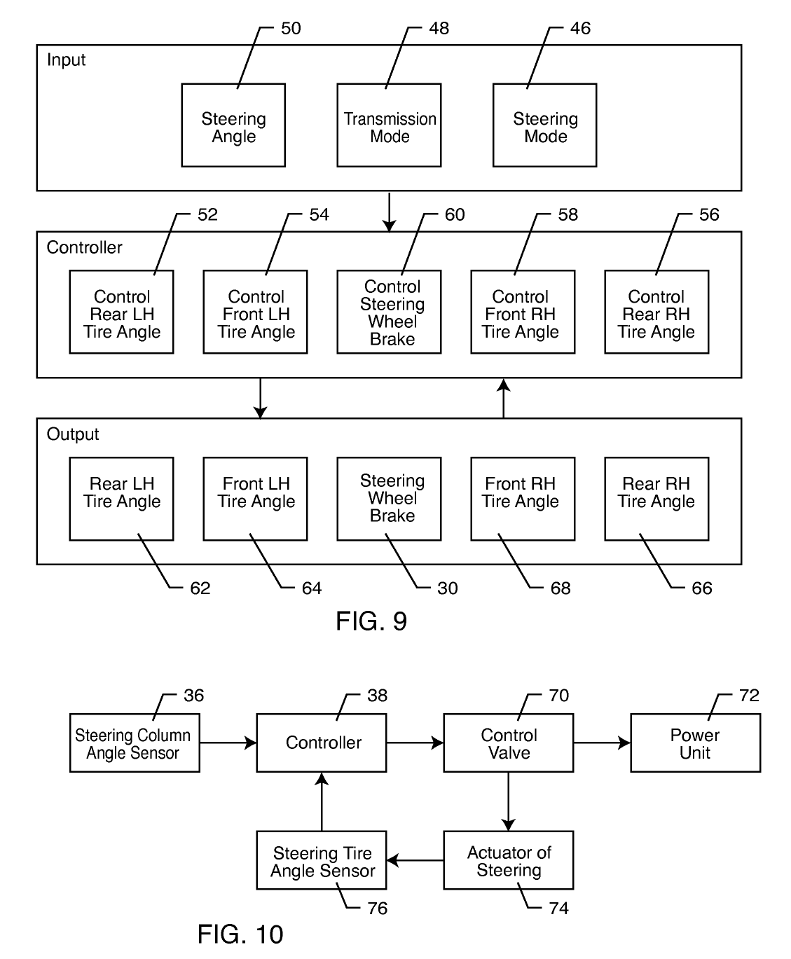

FIG. 9 illustrates a block diagram flowchart of a method for controlling the electronic steering system. The controller 38 receives input data relating to a steering mode 46, a transmission mode 48 and a steering angle 50. The steering mode 46 corresponds to the various steer modes discussed above. The transmission mode 48 corresponds to the various transmission buttons 42 discussed in connection with the display 40. The steering angle 50 corresponds to the rotational position of the steering column 20. This input data is transmitted to the controller 38 which interprets the steering mode 46 to determine the appropriate starting position of the tires and the transmission mode 48 to determine how much drive force is to be applied to which tires. The steering angle 50 tells the controller 38 how to adjust the position of the tires according to the constraints of the current steer mode.

The controller 38 has separate controllers for controlling each of the left rear tire angle 52, the left front tire angle 54, the right rear tire angle 56, the right front tire angle 58 and the steering brake 60. The controller 38 outputs appropriate signals to each of the left rear tire 62, left front tire 64, right rear tire 66, right front tire 68 and steering brake 30 to adjust the physical position thereof, i.e., angle or constriction. The physical position of each element is then communicated back to the controller 38 so that it knows where each element is when it next receives an input signal.

FIG. 10 further illustrates this control loop. The steering column angle sensor 36 communicates with the controller 38. The controller 38 then sends a signal to a control valve 70 which communicates with the power unit 72 and a steering actuator 74. The steering actuator 74 acts on an associated tire 62, 64, 66, 68. There is a steering actuator 74 for each tire. A tire angle sensor 76 then communicates the angle of the tire back to the controller 38 where it awaits another input signal.

Although several embodiments have been described for purposes of illustration, various modifications may be made without departing from the scope and spirit of the invention. Accordingly, the invention is not to be limited, except as by the appended claims.

What is claimed is:

1. An electronic steering system for a vehicle, comprising:
a rotating steering column;
a sensor for determining a rotational position of the steering column; and
a controller for turning tires on the vehicle based upon the rotational position of the steering column when the vehicle is in one of various steer modes, and for reestablishing a zero rotational position of the steering column when the vehicle is switched to another of the various steer modes.

2. The electronic steering system of claim 1, further comprising force feedback means for limiting over rotation of the steering column in either a clockwise or counter-clockwise direction.

3. The electronic steering system of claim 2, wherein the force feedback means comprises an electronic brake on the steering column.

4. The electronic steering system of claim 2, wherein the force feedback means prevents rotation of the steering column beyond one and one-half rotations in either a clockwise or counter-clockwise direction.

5. The electronic steering system of claim 2, wherein the steering column has a rotation range between negative-540 degrees and positive-540 degrees.

6. The electronic steering system of claim 2, wherein a zero rotational position of the force feedback means is reestablished when the vehicle is switched to another of the various steer modes.

7. The electronic steering system of claim 1, further comprising an electronic encoder associated with the steering column for communicating the rotational position of the steering column to the sensor.

8. An electronic steering system for a vehicle, comprising:
a rotating steering column;
a sensor for determining a rotational position of the steering column;
an electronic encoder associated with the steering column for communicating the rotational position of the steering column to the sensor;
a controller for turning tires on the vehicle based upon the rotational position of the steering column when the vehicle is in one of various steer modes, and for reestablishing a zero rotational position of the steering column when the vehicle is switched to another of the various steer modes; and
force feedback means for limiting over rotation of the steering column in either a clockwise or counter-clockwise direction.

9. The electronic steering system of claim 8, wherein the force feedback means comprises an electronic brake on the steering column.

10. The electronic steering system of claim 8, wherein the force feedback means prevents rotation of the steering column beyond one and one-half rotations in either a clockwise or counter-clockwise direction.

11. The electronic steering system of claim 8, wherein the steering column has a rotation range between negative-540 degrees and positive-540 degrees.

12. The electronic steering system of claim 8, wherein a zero rotational position of the force feedback means is reestablished when the vehicle is switched to another of the various steer modes.

13. A method for controlling an electronic steering system in a vehicle, comprising the steps of:
providing a rotating steering column;
selecting a first steer mode for the vehicle which defines a first position and alignment of tires on the vehicle;
establishing a zero rotational position of the steering column;
selecting a second steer mode for the vehicle which defines a second position and alignment of tires on the vehicle; and
electronically resetting the rotational position of the steering column such that the steering column is restored to the zero rotational position when switched to the second steer mode.

14. The method of claim 13, further comprising the step of operating the vehicle in the first steer mode such that a change in rotational position of the steering column alters the position and alignment of the tires according to constraints of the first steer mode.

15. The method of claim 13, further comprising the step of operating the vehicle in the second steer mode such that a change in rotational position of the steering column alters the position and alignment of the tires according to constraints of the second steer mode.

16. The method of claim 13, further comprising the step of limiting over rotation of the steering column in either a clockwise or counter-clockwise direction.

17. The method of claim 16, wherein the limiting step further comprises the step of preventing rotation of the steering column beyond one and one-half rotations in either a clockwise or counter-clockwise direction.

18. The method of claim 16, wherein the limiting step further comprises the step of limiting free rotation of the steering column to a range between negative-540 degrees and positive-540 degrees.

19. The system of claim 16, wherein the electronically resetting step further comprises electronically resetting limits on rotation of the steering column.

20. A method for controlling an electronic steering system in a vehicle, comprising the steps of:
providing a rotating steering column;
selecting a first steer mode for the vehicle which defines a first position and alignment of tires on the vehicle;
establishing a zero rotational position of the steering column;
limiting over rotation of the steering column in either a clockwise or counter-clockwise direction;
selecting a second steer mode for the vehicle which defines a second position and alignment of tires on the vehicle; and
electronically resetting the rotational position of the steering column and the limits on rotation of the steering column such that the steering column is restored to the zero rotational position when switched to the second steer mode.

21. The method of claim 20, further comprising the step of operating the vehicle in the first steer mode such that a change in rotational position of the steering column alters the position and alignment of the tires according to constraints of the first steer mode.

22. The method of claim 20, further comprising the step of operating the vehicle in the second steer mode such that a change in rotational position of the steering column alters the position and alignment of the tires according to constraints of the second steer mode.

23. The method of claim 20, wherein the limiting step further comprises the step of preventing rotation of the steering column beyond one and one-half rotations in either a clockwise or counter-clockwise direction.

24. The method of claim 20, wherein the limiting step further comprises the step of limiting rotation of the steering column to a range between negative-540 degrees and positive-540 degrees.
